(19) United States
(12) Patent Application Publication
(10) Pub. No.: US 2026/0303431 A1
(43) Pub. Date: Oct. 1, 2026

(54) NUMBER OF SUPPORTED UL MUTING PATTERNS PER PUSCH TYPE AND PER SLOT

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US)

(21) Appl. No.: 19/093,958

(22) Filed: Mar. 28, 2025

(51) Int. Cl. H04L 27/26; H04W 72/21

(52) U.S. Cl. CPC H04L 27/2636; H04L 27/2678; H04W 72/21

(57) ABSTRACT

Apparatus, methods, and computer program products for wireless communication are provided. An example method may include transmitting, to a network node, at least one UE capability signaling including at least one indication of: at least one total number of supported uplink (UL) resource muting patterns associated with a type 1 configured grant (CG) physical uplink shared channel (PUSCH) for at least one of a cyclic prefix (CP)-orthogonal frequency division multiplexing (OFDM) (CP-OFDM) waveform and a discrete Fourier transform-spread OFDM (DFT-s-OFDM) waveform, or at least one total UL resource muting number of symbols per slot. The example method may further include communicating with the network node based on the at least one UE capability signaling.

### TECHNICAL FIELD

The present disclosure relates generally to communication systems, and more particularly, to wireless communication systems with uplink (UL) muting.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) transmit, to a network node, at least one UE capability signaling including at least one indication of: at least one total number of supported uplink (UL) resource muting patterns associated with a type 1 configured grant (CG) physical uplink shared channel (PUSCH) for at least one of a cyclic prefix (CP)-orthogonal frequency division multiplexing (OFDM) (CP-OFDM) waveform and a discrete Fourier transform-spread OFDM (DFT-s-OFDM) waveform, or at least one total UL resource muting number of symbols per slot. Based at least in part on information stored in the at least one memory, the at least one processor, individually or in any combination, is configured to communicate with the network node based on the at least one UE capability signaling.

In another aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor, individually or in any combination, is configured to receive, from a UE, at least one UE capability signaling including at least one indication of: at least one total number of supported UL resource muting patterns associated with a type 1 CG PUSCH for at least one of a CP-OFDM waveform and DFT-s-OFDM waveform, or at least one total UL resource muting number of symbols per slot. Based at least in part on information stored in the at least one memory, the at least one processor, individually or in any combination, is configured to communicate with the UE based on the at least one UE capability signaling.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4A is a diagram illustrating a first type of full-duplex communication, in accordance with various aspects of the present disclosure.

FIG. 4B is a diagram illustrating a second type of full-duplex communication, in accordance with various aspects of the present disclosure.

FIG. 5A is a diagram illustrating example communication between full duplex network entity and half duplex UE, in accordance with various aspects of the present disclosure.

FIG. 5B is a diagram illustrating example communication between full duplex network entity and full duplex UE, in accordance with various aspects of the present disclosure.

FIG. 5C is a diagram illustrating example communication between half duplex network entity and full duplex UE, in accordance with various aspects of the present disclosure.

FIG. 6A is a diagram illustrating an example of non-overlapping UL/DL subband full duplex (SBFD), in accordance with various aspects of the present disclosure.

FIG. 6B is a diagram illustrating an example of partially overlapping UL/DL SBFD, in accordance with various aspects of the present disclosure.

FIG. 6C is a diagram illustrating an example of partially overlapping UL/DL SBFD, in accordance with various aspects of the present disclosure.

FIG. 7 is a diagram illustrating example crosslink interference (CLI), in accordance with various aspects of the present disclosure.

FIG. 8 is a diagram illustrating example CLI, in accordance with various aspects of the present disclosure.

FIG. 9 is a diagram illustrating example communications between a network node and a UE, in accordance with various aspects of the present disclosure.

FIG. 10 is a diagram illustrating an example of a UL muting configuration, in accordance with various aspects of the present disclosure.

FIG. 11 is a diagram illustrating an example of a UL muting configuration, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a diagram illustrating an example of a hardware implementation for an example apparatus and/or network entity, in accordance with various aspects of the present disclosure.

FIG. 15 is a diagram illustrating an example of a hardware implementation for an example network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Aspects provided herein provide mechanisms for a user equipment to signal its support number(s) of uplink resource muting symbols for each type of physical uplink shared channel per slot or a total number of supported uplink resource muting symbols per slot to facilitate the network node to configure the uplink resource muting configuration accordingly. Such aspects may facilitate improvement on the performance of uplink resource muting and related interference management, resulting in better overall efficiency.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

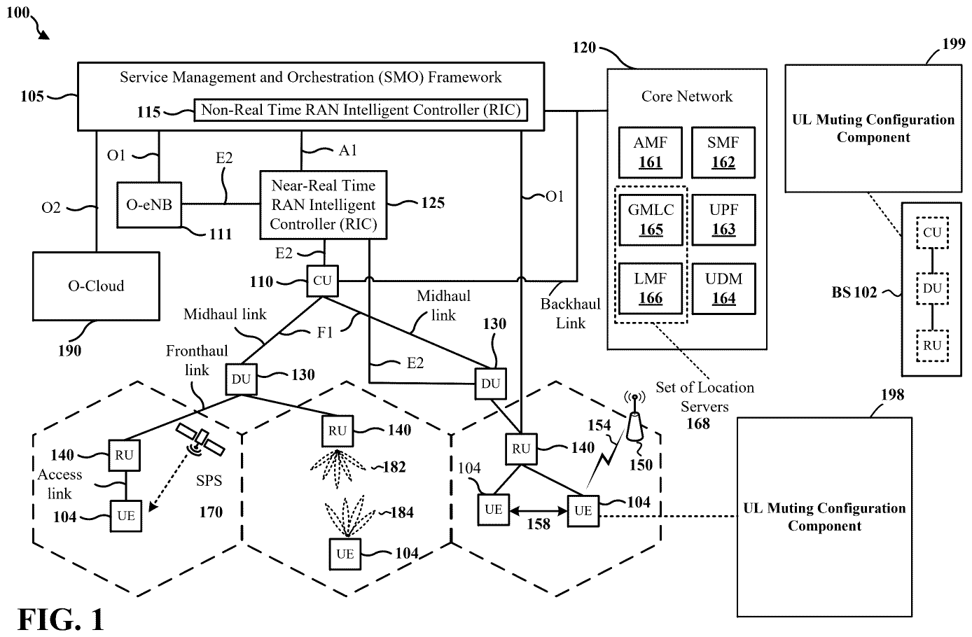

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a UL muting configuration component 198. In some aspects, the UL muting configuration component 198 may be configured to transmit, to a network node, at least one UE capability signaling including at least one indication of: at least one total number of supported uplink (UL) resource muting patterns associated with a type 1 configured grant (CG) physical uplink shared channel (PUSCH) for at least one of a cyclic prefix (CP)-orthogonal frequency division multiplexing (OFDM) (CP-OFDM) waveform and a discrete Fourier transform-spread OFDM (DFT-s-OFDM) waveform, or at least one total UL resource muting number of symbols per slot. In some aspects, the UL muting configuration component 198 may be further configured to communicate with the network node based on the at least one UE capability signaling.

In certain aspects, the base station 102 may include a UL muting configuration component 199. In some aspects, the UL muting configuration component 199 may be configured to receive, from a user equipment (UE), at least one UE capability signaling including at least one indication of: at least one total number of supported uplink (UL) resource muting patterns associated with a type 1 configured grant (CG) physical uplink shared channel (PUSCH) for at least one of a cyclic prefix (CP)-orthogonal frequency division multiplexing (OFDM) (CP-OFDM) waveform and a discrete Fourier transform-spread OFDM (DFT-s-OFDM) waveform, or at least one total UL resource muting number of symbols per slot. In some aspects, the UL muting configuration component 199 may be further configured to communicate with the UE based on the at least one UE capability signaling.

Although the following description may be focused on 5G NR, the concepts described herein may be applicable to other similar areas, such as 6G, LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

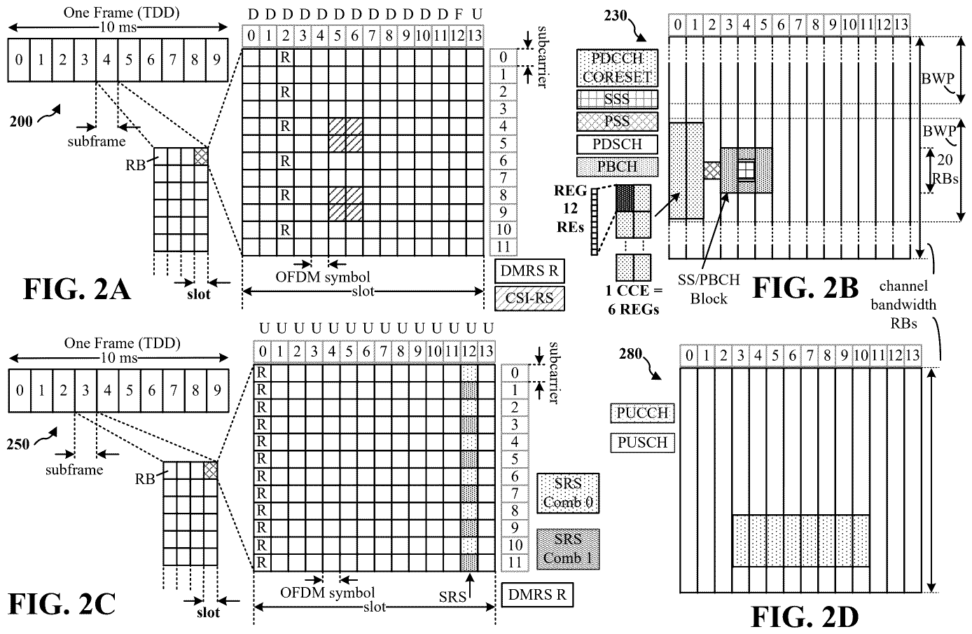

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

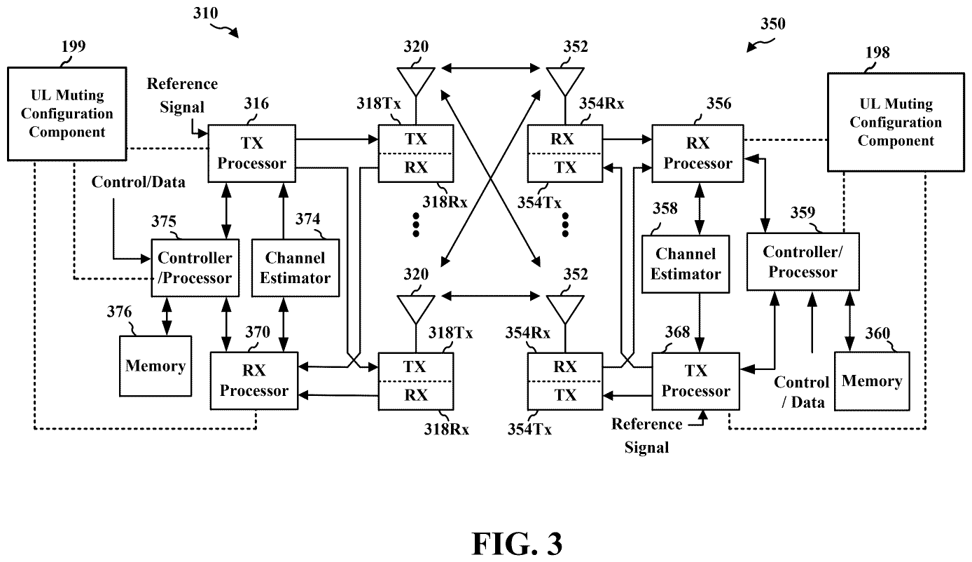

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with UL muting configuration component 198 of FIG. 1.

At least one of the TX processor 316, the RX processor 370, and the controller/processor 375 may be configured to perform aspects in connection with UL muting configuration component 199 of FIG. 1.

In some wireless communication systems, full-duplex (FD) capability (supporting simultaneous UL or DL transmission) may be present at the network node (such as a base station), the UE, or both the network node and the UE. For example, at the UE, UL transmissions may be transmitted from a first panel of the UE while simultaneous DL receptions may be received at a second panel of the UE. The first panel and the second panel may be different panels of the antenna(s) on the UE. As another example, at the base station, UL receptions may be received from a first panel of the base station while simultaneous DL transmissions may be transmitted at a second panel of the base station. The first panel and the second panel may be different panels of the antenna(s) on the base station. By supporting FD, latency of communications may be potentially reduced. For example, it may be possible for a UE to receive DL signal in slots assigned for UL, which may enable latency savings. Furthermore, by supporting FD, spectrum efficiency per cell and per UE may be improved because resource utilization over the spectrum may be more efficient.

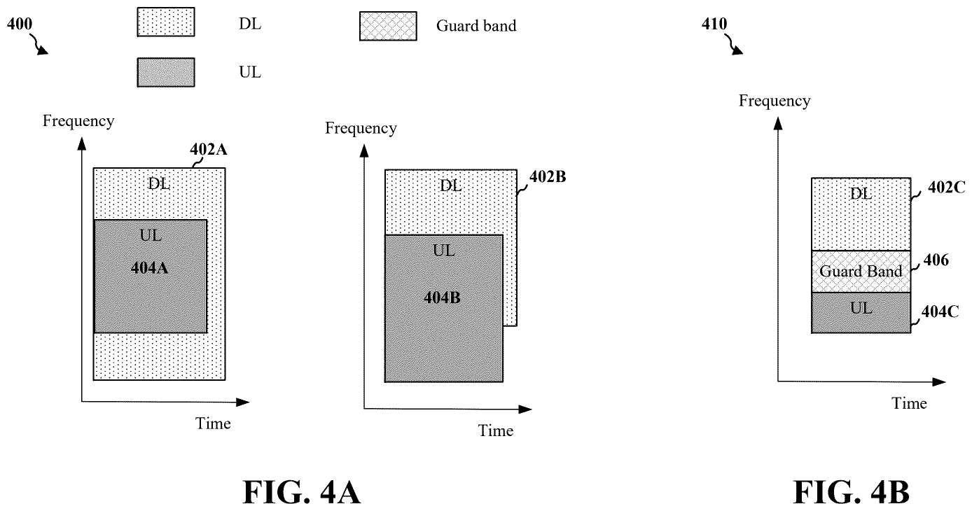

Full-duplex operation may be in the form of in-band full-duplex (IBFD) or sub-band frequency division duplexing (FDD) (otherwise known as “flexible duplex”). As illustrated in diagram 400 in FIG. 4A, for IBFD, the transmission and reception may occur at the same time, e.g., overlapping in time, and on the same frequency resource, e.g., using overlapping frequency resources. As illustrated in FIG. 4A, the IBFD time/frequency resources for downlink 402A and IBFD time/frequency resources for uplink 404A may be fully overlapped in some examples. In other examples, IBFD time/frequency resources for downlink 402B and IBFD time/frequency resources for uplink 404B may be partially overlapped, as illustrated in FIG. 4A.

For sub-band FDD, as illustrated in diagram 410 in FIG. 4B, the transmission and reception may occur at the same time, e.g., at least partially overlapping in time, but on different frequency resources. The downlink resources 402C may be separated from the uplink resources 404C in frequency domain. The separation may be referred to as a guard band 406, for example, and may provide a frequency gap or frequency separation between the downlink resources 402C and the uplink resources 404C. In some aspects, the network node may transmit and receive at the same time but on different frequency resource.

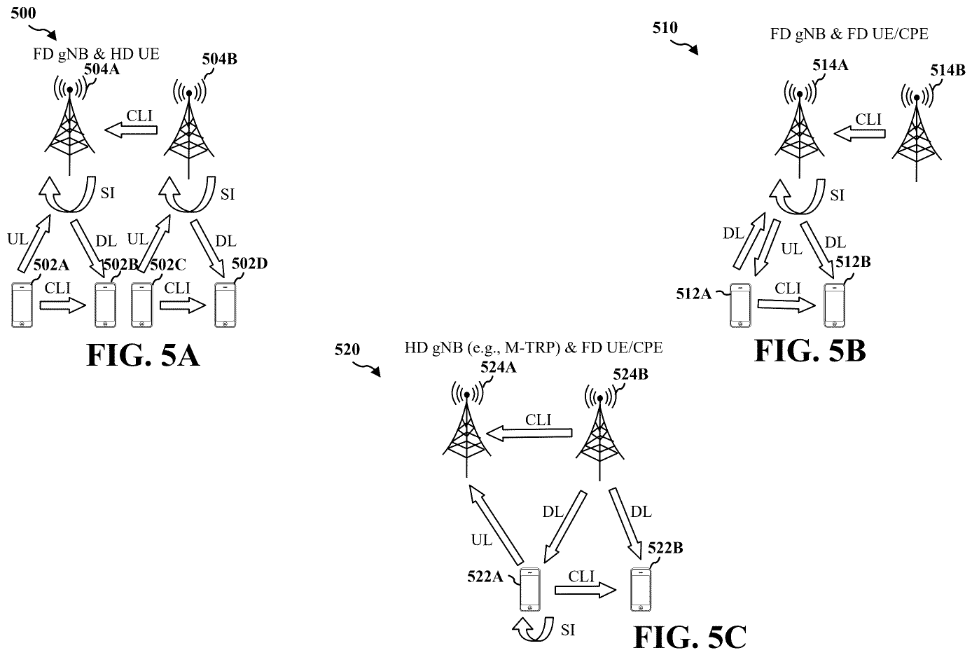

FIG. 5A is a diagram 500 illustrating example communication between a full duplex network entity and a half duplex UE. As illustrated in diagram 500 in FIG. 5A, two TRPs, TRP 504A and TRP 504B operating in full-duplex mode and four UEs, UE 502A, UE 502B, UE 502C, and UE 502D operating in half-duplex mode are shown in the depicted example. While the TRP 504A may be simultaneously transmitting downlink data to the UE 502B and receiving uplink data from the UE 502A, self-inference between the uplink reception and the downlink transmission at the TRP 504A may occur. For example, a receiver at the TRP may receive the transmitted downlink signal as interference to the uplink signal. Similarly, self-interference between the uplink reception and the downlink transmission at the TRP 504B may occur. In some aspects, because the UE 502B may be receiving downlink data and the UE 502A may be simultaneously transmitting uplink data, the transmission from the UE 502A may cause cross-link interference (CLI) to the downlink signal being received by the UE 502B. Similarly, the transmission from the UE 502C may cause CLI to the downlink signal being received by the UE 502D. Moreover, because the TRP 504B may also be receiving uplink data from the UE 502C and transmitting downlink data to the UE 502D, CLI between the TRP 504A and the TRP 504B may occur.

FIG. 5B is a diagram 510 illustrating example communication between full duplex network entity and full duplex UE. As illustrated in diagram 500 in FIG. 5A, two TRPs, TRP 514A and TRP 514B operating in full-duplex mode and two UEs, UE 512A and UE 512B operating in full duplex mode are included. The TRP 514A may be transmitting a downlink transmission to the UE 512A while simultaneously receiving an uplink transmission from the UE 512A. The TRP 514A may be also transmitting a downlink transmission to the UE 512B. Self-interference from uplink transmission to downlink reception at the UE 512A may occur. Self-interference from downlink transmission to uplink reception at the TRP 514A may also occur. If the TRP 514B is transmitting at the same time, CLI may also occur at the TRP 514A.

FIG. 5C is a diagram 520 illustrating example communication between half duplex network entity and full duplex UE. As illustrated in FIG. 5C, a TRP 524A and a TRP 524B may be operating in a HD mode and a UE 522A and a UE 522B may be operating in a FD mode. The UE 522A may be simultaneously transmitting an uplink transmission to the TRP 524A and receiving a downlink transmission from the TRP 524B. At the same time, the UE 522B may be receiving a downlink transmission from the TRP 524B. Self-interference from uplink transmission to downlink reception at the UE 522A may occur. CLI may also occur for the UE 522B because the UE 522B may receive the uplink transmission from the UE 522A while receiving the downlink transmission from the TRP 524B.

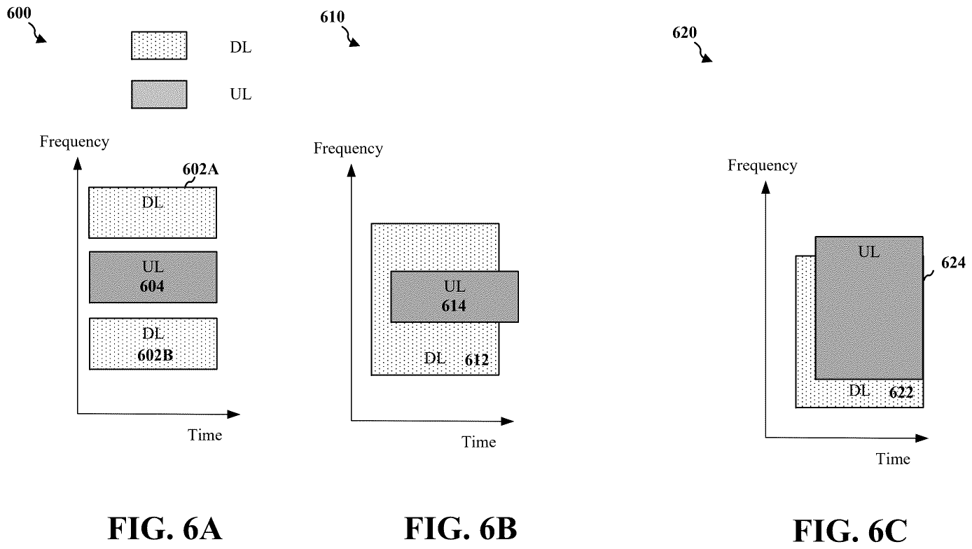

FIG. 6A is a diagram 600 illustrating an example of non-overlapping UL/DL subband full duplex (SBFD), in accordance with various aspects of the present disclosure. As illustrated in FIG. 6A, a first DL portion 602A may overlap in time with a UL portion 604 and a second DL portion 602B.

FIG. 6B is a diagram 610 illustrating an example of partially overlapping UL/DL SBFD, in accordance with various aspects of the present disclosure. A DL portion 612 may partially overlap in time with a UL portion 614.

FIG. 6C is a diagram 620 illustrating an example of partially overlapping UL/DL SBFD, in accordance with various aspects of the present disclosure. A DL portion 622 may partially overlap in time with a UL portion 624.

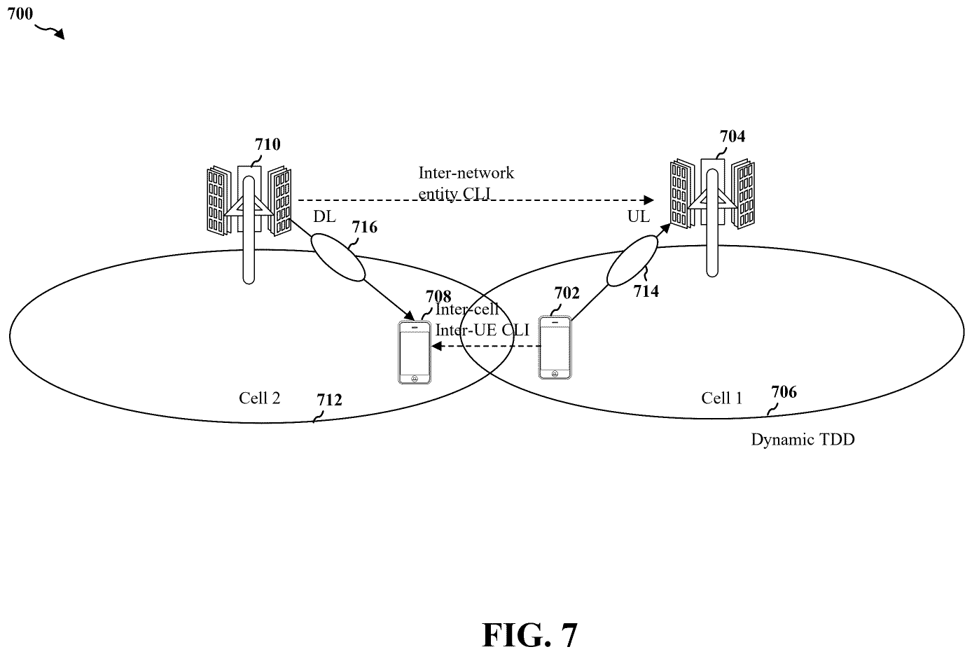

FIG. 7 is a diagram 700 illustrating example CLI. A first UE 702 may be within a first cell 706 and served by a first network entity 704 and a second UE 708 may be within a second cell 712 and served by a second network entity 710. CLI may occur between UEs at the cell edges of nearby cells, as UEs at cell edges of nearby cells may be in close proximity to each other. As illustrated in FIG. 7, the first UE 702 and the second UE 708 are respectively at cell edge of the first cell 706 and the second cell 712. The first UE 702 and the second UE 708 may be respective communication with the first network entity 704 and the second network entity 710. For example, the first UE 702 may transmit a UL transmission 714 to the first network entity 704 while the second UE 708 receives a DL transmission 716 from the second network entity 710. In some aspects, the UL transmission 714 to the first network entity 704 may also be received by the second UE 708, which may cause inter-UE CLI. As such, at the second UE 708, one or more symbols of the UL transmission 714 may collide with one or more symbols of the DL transmission 716. In addition to inter-UE CLI, inter-network entity CLI may also occur. For example, the first network entity 704 may receive the DL transmission 716 while receiving the UL transmission 714. As such, at the first network entity 704, one or more symbols of the UL transmission 714 may collide with one or more symbols of the DL transmission 716. The first network entity 704 may be referred to as a “victim network entity” or an “interfered network entity” because the first network entity 704 may be receiving a transmission not intended to be received by the first network entity 704 that interferes with a transmission that is intended to be received by the first network entity 704. Similarly, the second UE 708 may be referred to as a “victim UE or “interfered UE.” The second network entity 710 may be referred to as an “aggressor network entity” or “interfering network entity” because a transmission from the second network entity 710 may cause CLI to another network entity. Similarly, the first UE 702 may be referred to as an “aggressor UE” or an “interfering UE.” Aspects provided herein may provide mechanisms for reducing inter-network entity CLI for full duplex operations, increasing overall efficiency and throughput of the communication system.

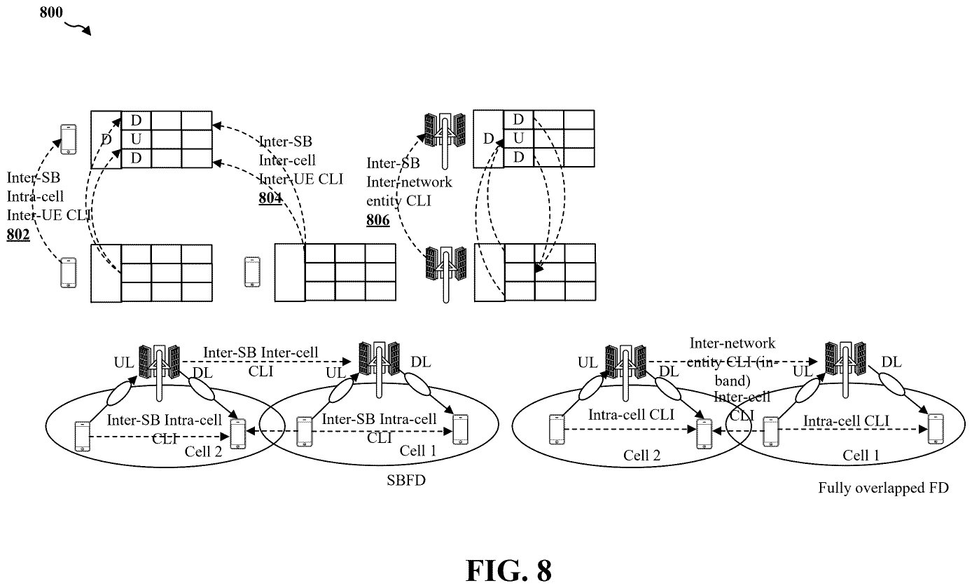

FIG. 8 is a diagram 800 illustrating example CLI. As illustrated in FIG. 8, CLI may be within a same cell or in different cells (intra-cell or inter-cell), within a same SB or in different SBs (intra-SB or inter-SB), between UEs (inter-UE) or between network entities (inter-network entity which may be otherwise referred to as inter-gNB). For example, in a communication system, there may be inter-SB, intra-cell, inter-UE CLI 802. There may also be inter-SB, inter-cell, and inter-UE CLI 804. There may also be inter-SB inter-network entity CLI 806.

Enhancements for CLI handling in SBFD-enabled systems may be implemented through various mechanisms, such as exchange of SBFD configuration information and UL resource muting for PUSCH. As used herein, the term “uplink resource muting” refers to a mechanisms where a UE would restrict or disable uplink transmissions on specified time/frequency resources for interference management purposes. For example, if UL resource muting is applied on a symbol for a PUSCH, the UL resource muting may be applied to a number of PRBs of all of the allocated PRBs of the PUSCH on that symbol based on a pattern, such as a comb-2 pattern (a pattern where every second PRB may be subject to muting, which would be an alternating pattern). As an example, for the reference point of time location of UL resource muting for PUSCH, a starting symbol of a slot for both PUSCH mapping type A or PUSCH mapping type B may be used. As an example, to determine the time location of UL muting symbol(s) in a slot for a PUSCH, the time location for each of one or two UL muting symbols may be configured (e.g., semi-statically), and muting the configured time location of UL muting symbol(s) (which may be zero, one, or two) may be dynamically turned on or turned off based on time domain resource allocation (TDRA) field of downlink control information (DCI) associated with the PUSCH. For exchange of SBFD configuration information, semi-static cell-specific time and frequency location configuration associated with SBFD may be exchanged between network entities. Measurement resource configuration, including SSB or periodic non-zero power channel state information reference signals (NZP CSI-RS), may be exchanged to facilitate interference management. Information related to the strongest downlink (DL) beam may be exchanged to improve CLI mitigation strategies. A CLI-mitigation request may be exchanged between network nodes. Regarding UL resource muting for PUSCH, UL resource muting for PUSCH may be determined based on a semi-static configuration, a comb-2 structure may be applied for both discrete Fourier transform spread orthogonal frequency division multiplexing (DFT-S-OFDM) and cyclic prefix-OFDM (CP-OFDM) within each allocated PRB. As an example, the muting may be applied for up to two symbols in the time domain. PUSCH resource mapping may be configured to perform rate-matching around the muted REs. Uplink control information (UCI) resource determination may be performed for symbols containing muted REs. As an example, UL resource muting may be applicable to UEs in RRC connected mode. As an example, the UE may assume that the UL resource muting pattern does not overlap with UL DM-RS or phase tracking reference signals (PT-RS) within the same symbol. Power boosting may be applied to other REs within the symbol where UL resource muting is applied, where the total PUSCH transmit power remains unchanged across symbols.

As an example, in some wireless communication systems, uplink resource muting for PUSCH may be indicated or determined based on a semi-static configuration. This approach assumes the use of comb-2 for both DFT-s-OFDM and CP-OFDM in each allocated physical resource block (PRB), with up to two symbols considered in the time domain. PUSCH resource mapping includes rate matching around the muted resource elements (REs), and uplink control information (UCI) resources may also be determined in symbols that include muted REs. As an example, UL resource muting does not apply for message A PUSCH and message 3 PUSCH in a RACH procedure. As an example, UL resource muting may be applicable for UEs in RRC connected mode but not RRC idle or inactive mode.

In some aspects, a UE may receive an allocation of resources for transmission or reception in a dynamic grant (DG), e.g., such as in DCI. A dynamic grant PUSCH, for example, is a PUSCH transmission that is transmitted using resources scheduled or allocated via DCI, which may be referred to as a dynamic grant. In contrast, a configured grant PUSCH is a PUSCH transmission that is transmitted in resources that are configured in advance (e.g., in a configured grant). A configured grant (e.g., a CG) provides a UE with periodic or semi-persistent resources that the UE may use for uplink transmissions to the network. For example, the network may provide one or more configured grants of recurring resources for uplink transmission in RRC signaling to the UE. For some types of configured grants, (e.g., such as a type 1 configured grant) the UE may use the allocated resources based on the RRC configuration and without activation or control signaling from the network. In other types of configured grants (e.g., such as a type 2 configured grant), the UE may further receive an indication after the RRC configuration to indicate that the configured grant is activated or enabled for the UE to use. The indication may be received in a MAC-CE or DCI. The UE may then use the recurring resources of the configured grant for uplink transmissions, e.g., until the UE receives signaling from the network that the configured grant is deactivated. In some aspects, the UE may receive RRC signaling configuring multiple configured grants for the UE, and the UE may then receive a MAC-CE that activates one or more of the configured grants from the RRC signaling. The configured grant provides the UE with an allocation of resources that the UE can use for uplink transmissions without individual grants, e.g., in DCI, for individual uplink transmissions. The configured grant can reduce the overhead for signaling grants to the UE and can reduce latency for the UE to transmit uplink transmissions.

To determine the time location of UL muting symbols in a slot for a PUSCH, one of the following options may be selected for dynamic grant (DG) PUSCH and type 2 configured grant (CG) PUSCH. In the first option, the time location of one or two UL muting symbols may semi-statically configured and may not be dynamically indicated. In the second option, the time location of one or two UL muting symbols may also be semi-statically configured, and muting at all of these configured time locations may be dynamically turned on or off by the time domain resource assignment (TDRA) field in the DCI. In the third option, the time location of one or more UL muting symbols is semi-statically configured, and none, one, or two of these time locations may be dynamically indicated by the TDRA field in the DCI. For type 1 CG PUSCH, the time location of one or two UL muting symbols in a slot may be semi-statically configured.

For the semi-statically configured time location and frequency location of UL muting symbol(s) for PUSCH, there may be separate configurations of up to two UL muting symbols that can be provided per UE for DG PUSCH/type 2 CG PUSCH and type 1 CG PUSCH.

As an example, DG PUSCH may be scheduled based on DCI where the DCI carries scheduling information (e.g., indicates time and frequency domain resources) for the DG PUSCH. CG PUSCH may be configured in advance and there may be no dynamic scheduling every time. Type 1 CG PUSCH may be based on configured time domain positions in a slot (e.g., symbol 2 to 4 every 10 ms) with no additional DCI trigger, and the UE may use the resources periodically as configured. Type 2 CG PUSCH may be based on configured time-domain positions and further based on a DCI trigger that carries a flag to indicate usage of the configured resources may be enabled.

The time location of UL muting symbol(s) in a slot for a PUSCH, for DG PUSCH and type 2 CG PUSCH, is semi-statically configured, and muting all of the semi-statically configured time location of UL muting symbol(s) may be dynamically turned ON/OFF by TDRA field in DCI. Therefore, for DG PUSCH and type 2 CG PUSCH, the network node may configure one muting pattern. For the semi-statically configured time location and frequency location of UL muting symbol(s) for PUSCH, separate configurations of up to two UL muting symbols may be provided per UE for DG PUSCH/type 2 CG PUSCH and type 1 CG PUSCH. Separate configuration for each of multiple type 1 CG PUSCH configurations supported. Therefore, the network node may configure more than one type 1 CG PUSCH configurations and configure one or more muting patterns for the more than one type 1 CG PUSCH configurations. For the UE, similar as DG PUSCH and type 2 CG PUSCH, the network node may determine to configure UL muting or not for each of type 1 CG PUSCH configuration. Aspects provided herein provide mechanisms for a user equipment to signal its support number(s) of uplink resource muting symbols for each type of physical uplink shared channel per slot or a total number of supported uplink resource muting symbols per slot to facilitate the network node to configure the uplink resource muting configuration accordingly. Such aspects may facilitate improvement on the performance of uplink resource muting and related interference management, resulting in better overall efficiency.

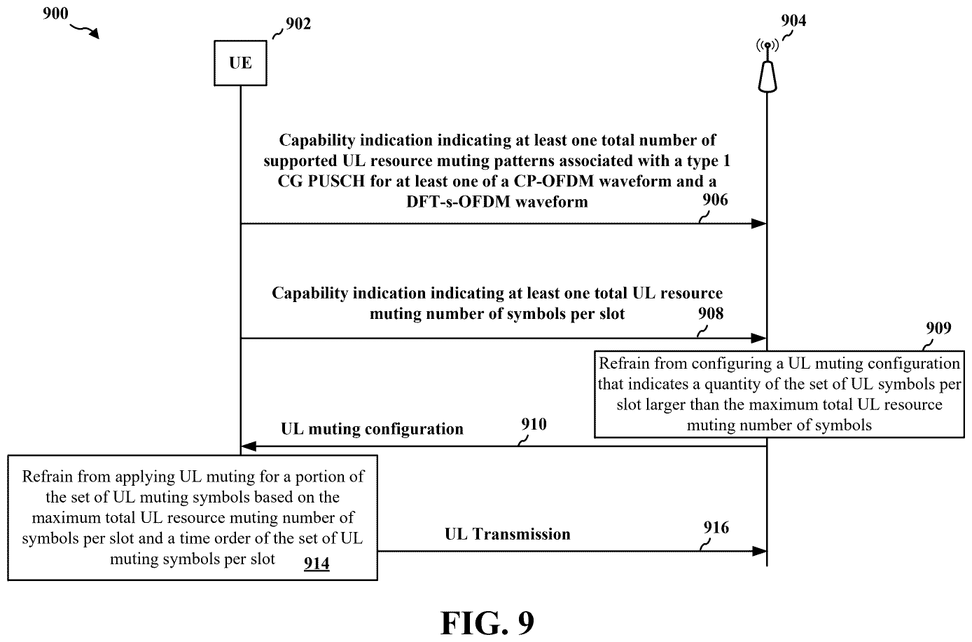

FIG. 9 is a diagram 900 illustrating example communications between a network node 904 and a UE 902, in accordance with various aspects of the present disclosure. As illustrated in FIG. 9, the UE 902 may transmit a capability indication 906 that indicates at least one total number of supported UL resource muting patterns associated with a type 1 CG PUSCH for at least one of a CP-OFDM waveform and DFT-s-OFDM waveform and a capability indication 908 that indicates at least one total UL resource muting number of symbols per slot. In some aspects, the capability indication 906 and the capability indication 908 may be included in a same capability signalling. In some aspects, the capability indication 906 and the capability indication 908 may be included in separate capability signalling. In some aspects, the UE 902 may receive a UL muting configuration 910 from the network node 904.

In some aspects, the capability indication 906 may indicate the total number of supported UL muting patterns for DG PUSCH/type 2 CG PUSCH and type 1 CG PUSCH for CP-OFDM. In some aspects, the capability indication 906 may indicate the total number of supported UL muting patterns for DG PUSCH/type 2 CG PUSCH and type 1 CG PUSCH for DFT-s-OFDM. Example candidate values may be [1,2,3,4,5,6,7,8]. For example, if UE reports that it supports two total number of supported UL muting patterns for DG PUSCH/type 2 CG PUSCH and type 1 CG PUSCH for CP-OFDM or DFT-s-OFDM, it means the UE supports one pattern for DG PUSCH/type 2 CG PUSCH and one different pattern for type 1 CG PUSCH for CP-OFDM or DFT-s-OFDM.

In some aspects, the capability indication 906 may indicate the total number of supported UL muting patterns for type 1 CG PUSCH for CP-OFDM (e.g., with default support UL muting pattern for DG PUSCH/type 2 CG PUSCH being one or another number).

In some aspects, the capability indication 906 may indicate the total number of supported UL muting patterns for type 1 CG PUSCH for DFT-s-OFDM (e.g., with default support UL muting pattern for DG PUSCH/type 2 CG PUSCH being one or another number). Example candidate values may be [1,2,3,4,5,6,7,8]. For example, if UE reports that it supports two total number of supported UL muting patterns for type 1 CG PUSCH for CP-OFDM or DFT-s-OFDM, it means UE supports two different patterns for type 1 CG PUSCH for CP-OFDM or DFT-s-OFDM.

In some aspects, the capability indication 906 may indicate the total number of supported UL muting patterns for DG PUSCH/type 2 CG PUSCH and type 1 CG PUSCH for both CP-OFDM and DFT-s-OFDM. Example candidate values may be [1,2,3,4,5,6,7,8]. For example, if the UE reports that it supports two total number of supported UL muting patterns for DG PUSCH/type 2 CG PUSCH and type 1 CG PUSCH for both CP-OFDM and DFT-s-OFDM, it means UE supports one pattern for DG PUSCH/type 2 CG PUSCH and one different pattern for type 1 CG PUSCH for both CP-OFDM and DFT-s-OFDM.

In some aspects, the capability indication 906 may indicate the total number of supported UL muting patterns for type 1 CG PUSCH for both CP-OFDM and DFT-s-OFDM (e.g., with default supported UL muting pattern for DG PUSCH/type 2 CG PUSCH being one or a different number). Example candidate values may be [1,2,3,4,5,6,7,8]. For example, if UE reports that it supports two total number of supported UL muting patterns for type 1 CG PUSCH for both CP-OFDM and DFT-s-OFDM, it means UE supports two different patterns for type 1 CG PUSCH for both CP-OFDM and DFT-s-OFDM.

In some aspects, the capability indication 908 may indicate the maximum number of supported UL muting symbols per slot for all DG PUSCH/type 2 CG PUSCH and type 1 CG PUSCH for CP-OFDM and/or DFT-s-OFDM. Example candidate values may be [1,2,3,4].

The time location of UL muting symbol(s) in a slot for a PUSCH may include different configurations, such as configuration(s) for DG PUSCH and type 2 CG PUSCH, and separate configuration(s) for type 1 CG PUSCH. Therefore, if the network node 904 schedules one DG PUSCH and one CG PUSCH in a slot for a UE, the network node may configure two muting symbols for DG PUSCH (e.g., at example symbols 1 and 6), and configures two muting symbols for CG PUSCH in the same slot (e.g., at example symbols 9, 13). It may also happen when the network node schedules type 1 CG PUSCH configuration 1 and type 1 CG PUSCH configuration 2 in a same slot for a UE. In this case, there could be more than 2 muting symbols per slot.

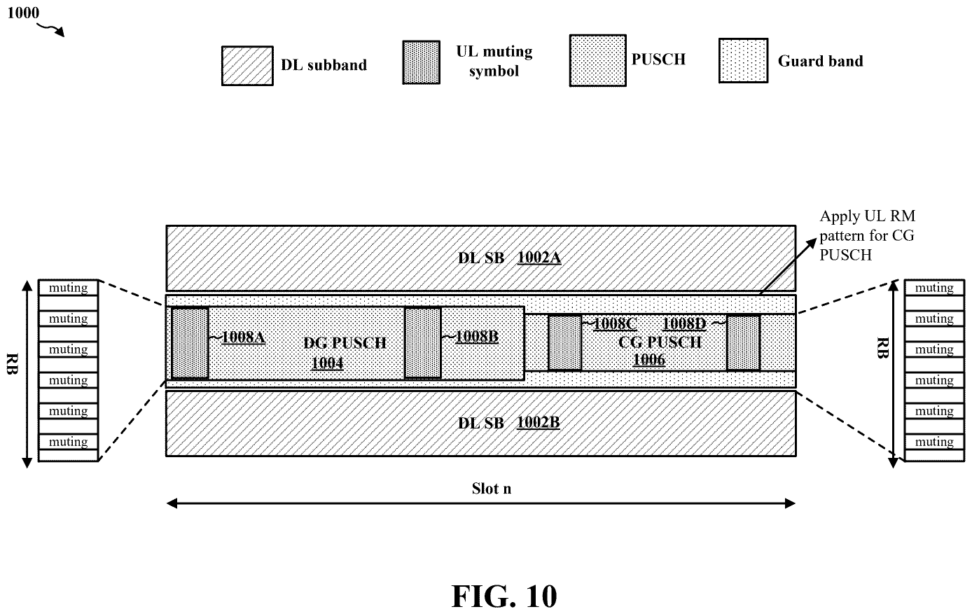

FIG. 10 is a diagram 1000 illustrating an example of a UL muting configuration, in accordance with various aspects of the present disclosure. As illustrated in FIG. 10, the network node may configure a first UL muting symbol 1008A and a second UL muting symbol 1008B for DG PUSCH 1004, and configure a third UL muting symbol 1008C and a fourth UL muting symbol 1008D for CG PUSCH 1006. There may be concurrent DL sub-bands that may be concurrent with the DG PUSCH 1004 and the CG PUSCH 1006, such as a first DL-subband 1002A and a second DL-subband 1002B. Within each muting symbol, by way of example, every other subcarrier may be muted.

If the network node configures a quantity (e.g., total quantity) of UL muting symbols per slot larger than the maximum number of supported UL muting symbols per slot for all of DG PUSCH/type 2 CG PUSCH and type 1 CG PUSCH for CP-OFDM and/or DFT-s-OFDM reported by the UE (e.g., in capability indication 908), in some aspects, the UE 902 may not apply the nth number of UL muting symbols if n is larger than the maximum number of supported UL muting symbols per slot for all of DG PUSCH/type 2 CG PUSCH and type 1 CG PUSCH for CP-OFDM and/or DFT-s-OFDM reported by the UE. In other words, at 914, the UE 902 may refrain from applying UL muting for a portion of the set of UL muting symbols based on the maximum total UL resource muting number of symbols per slot and a time order of the set of UL muting symbols per slot.

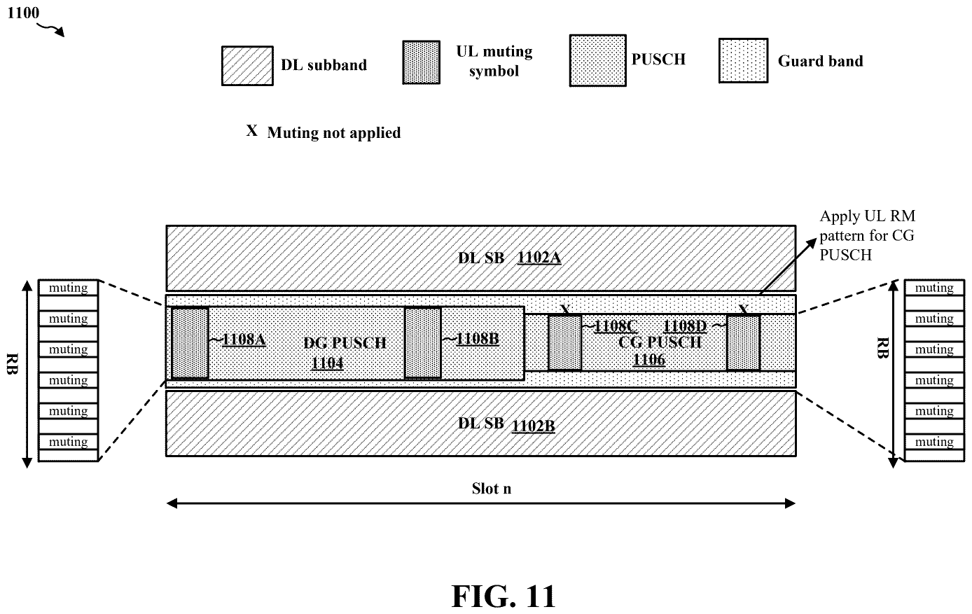

FIG. 11 is a diagram 1100 illustrating an example of a UL muting configuration, in accordance with various aspects of the present disclosure. As illustrated in FIG. 11, the network node may configure a first UL muting symbol 1108A and a second UL muting symbol 1108B for DG PUSCH 1104, and configure a third UL muting symbol 1108C and a fourth UL muting symbol 1108D for CG PUSCH 1106. There may be concurrent DL sub-bands that may be concurrent with the DG PUSCH 1104 and the CG PUSCH 1106, such as a first DL-subband 1102A and a second DL-subband 1102B. Within each muting symbol, by way of example, every other subcarrier may be muted. The UE may not apply the nth number of UL muting symbols if n is larger than the maximum number of supported UL muting symbols per slot for all of DG PUSCH/type 2 CG PUSCH and type 1 CG PUSCH for CP-OFDM and/or DFT-s-OFDM reported by the UE. Therefore, if the UE the maximum number of supported UL muting symbols per slot for all of DG PUSCH/type 2 CG PUSCH and type 1 CG PUSCH for CP-OFDM and/or DFT-s-OFDM reported by the UE in the capability indication 908 is two, the UE may not apply UL muting on the third UL muting symbol 1108C and the fourth UL muting symbol 1108D.

In some aspects, at 909, the network node may refrain from configuring a UL muting configuration that indicates a set of UL muting symbols per slot where a quantity of the set of UL symbols per slot is larger than the maximum total UL resource muting number of symbols. Therefore, in such aspects, the UE 902 may not expect a UL muting configuration 910 where the quantity (e.g., total quantity) of UL muting symbols per slot larger than the maximum number of supported UL muting symbols per slot for all of DG PUSCH/type 2 CG PUSCH and type 1 CG PUSCH for CP-OFDM and/or DFT-s-OFDM reported by the UE (e.g., in capability indication 908).

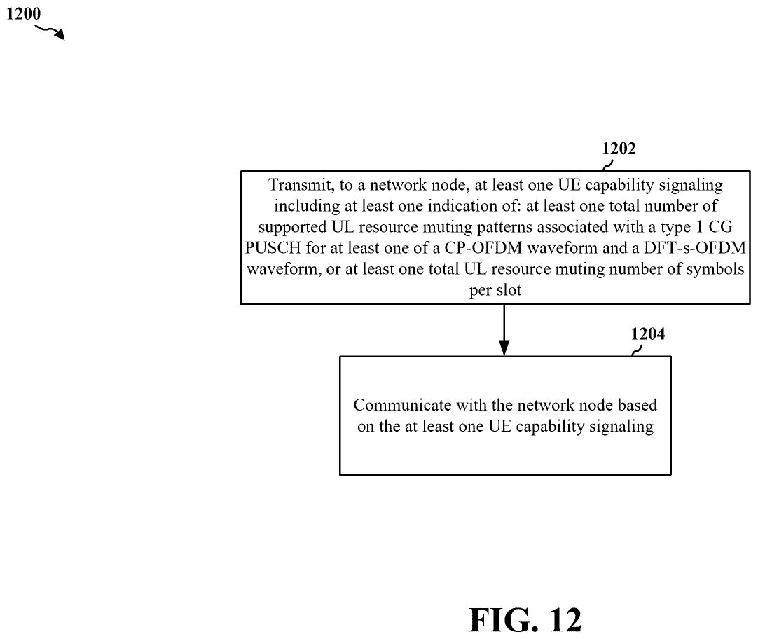

FIG. 12 is a flowchart 1200 of a method of wireless communication. The method may be performed by a UE (e.g., the UE 104, the UE 902; the apparatus 1404). The method may provide mechanisms for a user equipment to signal its support number(s) of uplink resource muting symbols for each type of physical uplink shared channel per slot or a total number of supported uplink resource muting symbols per slot to facilitate the network node to configure the uplink resource muting configuration accordingly. Such aspects may facilitate improvement on the performance of uplink resource muting and related interference management, resulting in better overall efficiency.

At 1202, the UE may transmit, to a network node, at least one UE capability signaling including at least one indication of: at least one total number of supported UL resource muting patterns associated with a type 1 CG PUSCH for at least one of a CP-OFDM waveform and a DFT-s-OFDM waveform, or at least one total UL resource muting number of symbols per slot. For example, the UE 902 may transmit, to a network node 904, at least one UE capability signaling including at least one indication of: at least one total number of supported UL resource muting patterns associated with a type 1 CG PUSCH for at least one of a CP-OFDM waveform and a DFT-s-OFDM waveform (e.g., 906), or at least one total UL resource muting number of symbols per slot (e.g., 908). In some aspects, 1202 may be performed by UL muting configuration component 198.

In some aspects, the at least one indication indicates the at least one total number of supported UL resource muting patterns associated with the type 1 CG PUSCH, a DG PUSCH, and a type 2 CG PUSCH for the CP-OFDM waveform.

In some aspects, the at least one indication indicates the at least one total number of supported UL resource muting patterns associated with the type 1 CG PUSCH, a DG PUSCH, and a type 2 CG PUSCH for the DFT-s-OFDM waveform.

In some aspects, the at least one indication indicates the at least one total number of supported UL resource muting patterns associated with the type 1 CG PUSCH for the CP-OFDM waveform, and where a first total number of supported UL resource muting patterns associated with a DG PUSCH and a type 2 CG PUSCH for the CP-OFDM waveform is one.

In some aspects, the at least one indication indicates the at least one total number of supported UL resource muting patterns associated with the type 1 CG PUSCH for the DFT-s-OFDM waveform, and where a first total number of supported UL resource muting patterns associated with a DG PUSCH and a type 2 CG PUSCH for the DFT-s-OFDM waveform is one.

In some aspects, the at least one total number of supported UL resource muting patterns associated with the type 1 CG PUSCH, a DG PUSCH, and a type 2 CG PUSCH for the CP-OFDM waveform and the DFT-s-OFDM waveform.

In some aspects, the at least one indication indicates the at least one indication indicates the at least one total number of supported UL resource muting patterns associated with the type 1 CG PUSCH for the DFT-s-OFDM waveform and the CP-OFDM waveform, and where a first total number of supported UL resource muting patterns associated with a DG PUSCH and a type 2 CG PUSCH for the DFT-s-OFDM waveform and the CP-OFDM waveform is one.

In some aspects, the at least one indication indicates the at least one total UL resource muting number of symbols per slot for the type 1 CG PUSCH, a DG PUSCH, and a type 2 CG PUSCH.

In some aspects, the at least one total UL resource muting number of symbols per slot for the type 1 CG PUSCH, the DG PUSCH, and the type 2 CG PUSCH corresponds to one maximum total UL resource muting number of symbols per slot for a combination of the type 1 CG PUSCH, the DG PUSCH, and the type 2 CG PUSCH.

At 1204, the UE may communicate with the network node based on the at least one UE capability signaling. For example, the UE 902 may communicate (e.g., at 910 or 916) with the network node based on the at least one UE capability signaling. In some aspects, 1204 may be performed by UL muting configuration component 198.

In some aspects, the UE may receive a UL muting configuration (e.g., 910) that indicates a set of UL muting symbols per slot, where a quantity of the set of UL symbols per slot larger than the maximum total UL resource muting number of symbols and refrain (e.g., 914) from applying UL muting for a portion (e.g., 1108C and 1108D) of the set of UL muting symbols based on the maximum total UL resource muting number of symbols per slot and a time order of the set of UL muting symbols per slot.

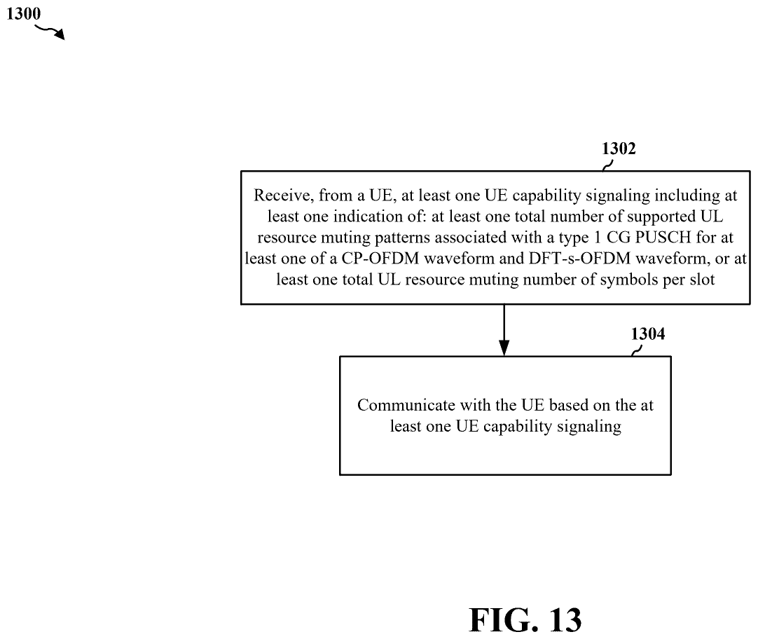

FIG. 13 is a flowchart 1300 of a method of wireless communication. The method may be performed by a network entity (e.g., the base station 102, the network node 904, the network entity 1402, the network entity 1502). The method may provide mechanisms for a user equipment to signal its support number(s) of uplink resource muting symbols for each type of physical uplink shared channel per slot or a total number of supported uplink resource muting symbols per slot to facilitate the network node to configure the uplink resource muting configuration accordingly. Such aspects may facilitate improvement on the performance of uplink resource muting and related interference management, resulting in better overall efficiency.

At 1302, the network node may receive, from a UE, at least one UE capability signaling including at least one indication of: at least one total number of supported UL resource muting patterns associated with a type 1 CG PUSCH for at least one of a CP-OFDM waveform and DFT-s-OFDM waveform, or at least one total UL resource muting number of symbols per slot. For example, the network node 904 may receive, from a UE 902, at least one UE capability signaling including at least one indication of: at least one total number of supported UL resource muting patterns associated with a type 1 CG PUSCH for at least one of a CP-OFDM waveform and DFT-s-OFDM waveform (e.g., 906), or at least one total UL resource muting number of symbols per slot (e.g., 908). In some aspects, 1302 may be performed by UL muting configuration component 199.

In some aspects, the at least one indication indicates the at least one total number of supported UL resource muting patterns associated with the type 1 CG PUSCH for the CP-OFDM waveform and a first total number of supported UL resource muting patterns associated with a dynamic grant (DG) PUSCH for the CP-OFDM waveform or a second total number of supported UL resource muting patterns associated with a type 2 CG PUSCH for the CP-OFDM waveform.

In some aspects, the at least one indication indicates the at least one total number of supported UL resource muting patterns associated with the type 1 CG PUSCH for the DFT-s-OFDM waveform and a first total number of supported UL resource muting patterns associated with a DG PUSCH for the DFT-s-OFDM waveform or a second total number of supported UL resource muting patterns associated with a type 2 CG PUSCH for the DFT-s-OFDM waveform.

In some aspects, the at least one indication indicates the at least one total number of supported UL resource muting patterns associated with the type 1 CG PUSCH for the CP-OFDM waveform, and where a first total number of supported UL resource muting patterns associated with a DG PUSCH for the CP-OFDM waveform or a second total number of supported UL resource muting patterns associated with a type 2 CG PUSCH for the CP-OFDM waveform is one.

In some aspects, the at least one indication indicates the at least one total number of supported UL resource muting patterns associated with the type 1 CG PUSCH for the DFT-s-OFDM waveform, and where a first total number of supported UL resource muting patterns associated with a DG PUSCH for the DFT-s-OFDM waveform or a second total number of supported UL resource muting patterns associated with a type 2 CG PUSCH for the DFT-s-OFDM waveform is one.

In some aspects, the at least one indication indicates the at least one total number of supported UL resource muting patterns associated with the type 1 CG PUSCH for the DFT-s-OFDM waveform and the CP-OFDM waveform and a first total number of supported UL resource muting patterns associated with a DG PUSCH for the DFT-s-OFDM waveform and the CP-OFDM waveform or a second total number of supported UL resource muting patterns associated with a type 2 CG PUSCH for the DFT-s-OFDM waveform and the CP-OFDM waveform.

In some aspects, the at least one indication indicates the at least one total number of supported UL resource muting patterns associated with the type 1 CG PUSCH for the DFT-s-OFDM waveform and the CP-OFDM waveform, and where a first total number of supported UL resource muting patterns associated with a DG PUSCH for the DFT-s-OFDM waveform and the CP-OFDM waveform or a second total number of supported UL resource muting patterns associated with a type 2 CG PUSCH for the DFT-s-OFDM waveform and the CP-OFDM waveform is one.

In some aspects, the at least one indication indicates the at least one total UL resource muting number of symbols per slot for the type 1 CG PUSCH, a DG PUSCH, and a type 2 CG PUSCH.

In some aspects, the at least one total UL resource muting number of symbols per slot for the type 1 CG PUSCH, the DG PUSCH, and the type 2 CG PUSCH corresponds to one maximum total UL resource muting number of symbols per slot for a combination of the type 1 CG PUSCH, the DG PUSCH, and the type 2 CG PUSCH.

At 1304, the network node may communicate with the UE based on the at least one UE capability signaling. For example, the network node 904 may communicate with the UE based on the at least one UE capability signaling. In some aspects, 1304 may be performed by UL muting configuration component 199.

In some aspects, the network node may refrain (e.g., 909) from configuring a UL muting configuration that indicates a set of UL muting symbols per slot where a quantity of the set of UL symbols per slot is larger than the maximum total UL resource muting number of symbols.

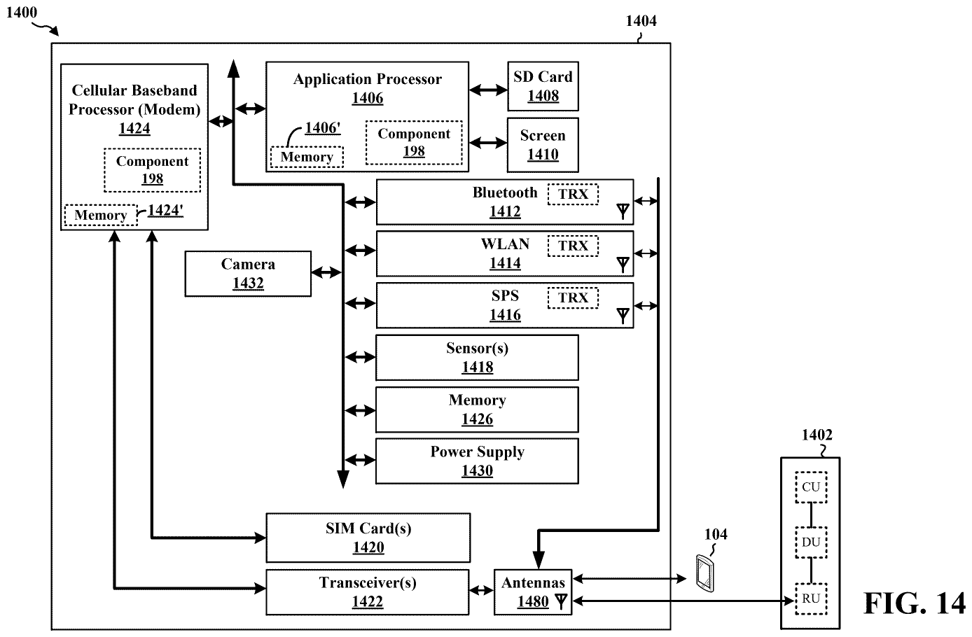

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the UL muting configuration component 198 may be configured to transmit, to a network node, at least one UE capability signaling including at least one indication of: at least one total number of supported uplink (UL) resource muting patterns associated with a type 1 configured grant (CG) physical uplink shared channel (PUSCH) for at least one of a cyclic prefix (CP)-orthogonal frequency division multiplexing (OFDM) (CP-OFDM) waveform and a discrete Fourier transform-spread OFDM (DFT-s-OFDM) waveform, or at least one total UL resource muting number of symbols per slot. In some aspects, the UL muting configuration component 198 may be further configured to communicate with the network node based on the at least one UE capability signaling. The UL muting configuration component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for transmitting, to a network node, at least one UE capability signaling including at least one indication of: at least one total number of supported uplink (UL) resource muting patterns associated with a type 1 configured grant (CG) physical uplink shared channel (PUSCH) for at least one of a cyclic prefix (CP)-orthogonal frequency division multiplexing (OFDM) (CP-OFDM) waveform and a discrete Fourier transform-spread OFDM (DFT-s-OFDM) waveform, or at least one total UL resource muting number of symbols per slot. In some aspects, the apparatus 1404 may include means for communicating with the network node based on the at least one UE capability signaling. In some aspects, the apparatus 1404 may include means for receiving a UL muting configuration that indicates a set of UL muting symbols per slot, where a quantity of the set of UL symbols per slot larger than the maximum total UL resource muting number of symbols. In some aspects, the apparatus 1404 may include means for refraining from applying UL muting for a portion of the set of UL muting symbols based on the maximum total UL resource muting number of symbols per slot and a time order of the set of UL muting symbols per slot. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means. The apparatus 1404 may be configured to perform any of the aspects described in the respective flowchart and/or performed by the corresponding device in the communication flow.

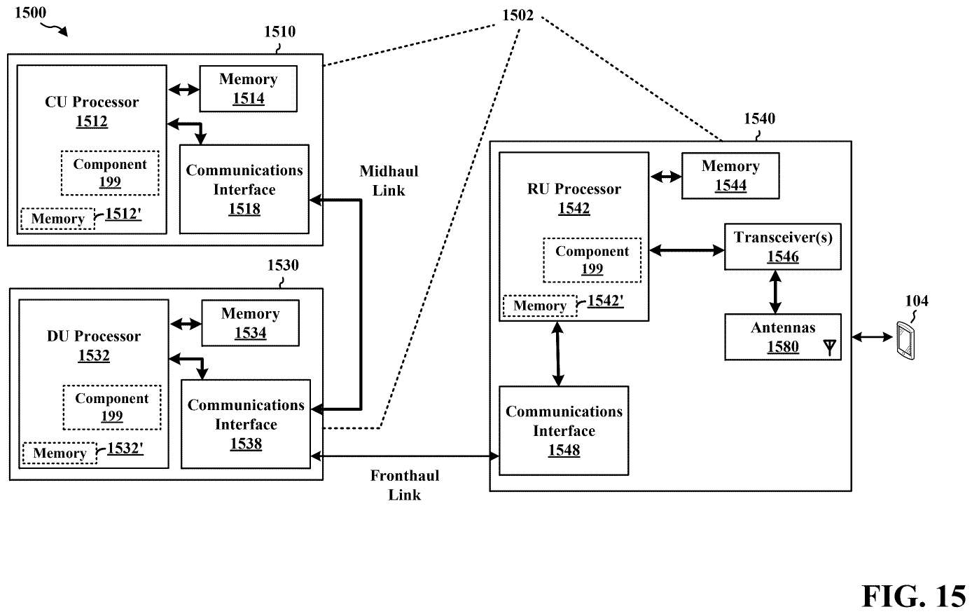

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the UL muting configuration component 199. In some aspects, the UL muting configuration component 199 may be configured to receive, from a user equipment (UE), at least one UE capability signaling including at least one indication of: at least one total number of supported uplink (UL) resource muting patterns associated with a type 1 configured grant (CG) physical uplink shared channel (PUSCH) for at least one of a cyclic prefix (CP)-orthogonal frequency division multiplexing (OFDM) (CP-OFDM) waveform and a discrete Fourier transform-spread OFDM (DFT-s-OFDM) waveform, or at least one total UL resource muting number of symbols per slot. In some aspects, the UL muting configuration component 199 may be further configured to communicate with the UE based on the at least one UE capability signaling. The UL muting configuration component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for receiving, from a user equipment (UE), at least one UE capability signaling including at least one indication of: at least one total number of supported uplink (UL) resource muting patterns associated with a type 1 configured grant (CG) physical uplink shared channel (PUSCH) for at least one of a cyclic prefix (CP)-orthogonal frequency division multiplexing (OFDM) (CP-OFDM) waveform and a discrete Fourier transform-spread OFDM (DFT-s-OFDM) waveform, or at least one total UL resource muting number of symbols per slot. In some aspects, the network entity 1502 may include means for communicating with the UE based on the at least one UE capability signaling. In some aspects, the network entity 1502 may include means for refraining from configuring a UL muting configuration that indicates a set of UL muting symbols per slot where a quantity of the set of UL symbols per slot is larger than the maximum total UL resource muting number of symbols. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means. The network entity 1502 may be configured to perform any of the aspects described in the respective flowchart and/or performed by the corresponding device in the communication flow.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE), including: at least one memory; and at least one processor coupled to the at least one memory, and based at least in part on information stored in the at least one memory, the at least one processor is configured to: transmit, to a network node, at least one UE capability signaling including at least one indication of: at least one total number of supported uplink (UL) resource muting patterns associated with a type 1 configured grant (CG) physical uplink shared channel (PUSCH) for at least one of a cyclic prefix (CP)-orthogonal frequency division multiplexing (OFDM) (CP-OFDM) waveform and a discrete Fourier transform-spread OFDM (DFT-s-OFDM) waveform; or at least one total UL resource muting number of symbols per slot; and communicate with the network node based on the at least one UE capability signaling.

Aspect 2 is the apparatus of aspect 1, where the at least one indication indicates: the at least one total number of supported UL resource muting patterns associated with the type 1 CG PUSCH, a dynamic grant (DG) PUSCH, and a type 2 CG PUSCH for the CP-OFDM waveform.

Aspect 3 is the apparatus of aspect 1, where the at least one indication indicates: the at least one total number of supported UL resource muting patterns associated with the type 1 CG PUSCH, a dynamic grant (DG) PUSCH, and a type 2 CG PUSCH for the DFT-s-OFDM waveform.

Aspect 4 is the apparatus of aspect 1, where the at least one indication indicates the at least one total number of supported UL resource muting patterns associated with the type 1 CG PUSCH for the CP-OFDM waveform, and where a first total number of supported UL resource muting patterns associated with a dynamic grant (DG) PUSCH and a type 2 CG PUSCH for the CP-OFDM waveform is one.

Aspect 5 is the apparatus of aspect 1, where the at least one indication indicates the at least one total number of supported UL resource muting patterns associated with the type 1 CG PUSCH for the DFT-s-OFDM waveform, and where a first total number of supported UL resource muting patterns associated with a dynamic grant (DG) PUSCH and a type 2 CG PUSCH wherefor the DFT-s-OFDM waveform is one.

Aspect 6 is the apparatus of aspect 1, where the at least one indication indicates: the at least one total number of supported UL resource muting patterns associated with the type 1 CG PUSCH, a dynamic grant (DG) PUSCH, and a type 2 CG PUSCH for the CP-OFDM waveform and the DFT-s-OFDM waveform.

Aspect 7 is the apparatus of aspect 1, where the at least one indication indicates the at least one total number of supported UL resource muting patterns associated with the type 1 CG PUSCH for the DFT-s-OFDM waveform and the CP-OFDM waveform, and where a first total number of supported UL resource muting patterns associated with a dynamic grant (DG) PUSCH and a type 2 CG PUSCH for the DFT-s-OFDM waveform and the CP-OFDM waveform is one.

Aspect 8 is the apparatus of any of aspects 1-7, where the at least one indication indicates the at least one total UL resource muting number of symbols per slot for the type 1 CG PUSCH, a dynamic grant (DG) PUSCH, and a type 2 CG PUSCH.

Aspect 9 is the apparatus of aspect 8, where the at least one total UL resource muting number of symbols per slot for the type 1 CG PUSCH, the DG PUSCH, and the type 2 CG PUSCH corresponds to one maximum total UL resource muting number of symbols per slot for a combination of the type 1 CG PUSCH, the DG PUSCH, and the type 2 CG PUSCH.

Aspect 10 is the apparatus of aspect 9, where the at least one processor is further configured to: receive a UL muting configuration that indicates a set of UL muting symbols per slot, where a quantity of the set of UL symbols per slot larger than the maximum total UL resource muting number of symbols; and refrain from applying UL muting for a portion of the set of UL muting symbols based on the maximum total UL resource muting number of symbols per slot and a time order of the set of UL muting symbols per slot.

Aspect 11 is an apparatus for wireless communication at a network node, including: at least one memory; and at least one processor coupled to the at least one memory, and based at least in part on information stored in the at least one memory, the at least one processor is configured to: receive, from a user equipment (UE), at least one UE capability signaling including at least one indication of: at least one total number of supported uplink (UL) resource muting patterns associated with a type 1 configured grant (CG) physical uplink shared channel (PUSCH) for at least one of a cyclic prefix (CP)-orthogonal frequency division multiplexing (OFDM) (CP-OFDM) waveform and a discrete Fourier transform-spread OFDM (DFT-s-OFDM) waveform; or at least one total UL resource muting number of symbols per slot; and communicate with the UE based on the at least one UE capability signaling.

Aspect 12 is the apparatus of aspect 11, where the at least one indication indicates: the at least one total number of supported UL resource muting patterns associated with the type 1 CG PUSCH, a dynamic grant (DG) PUSCH, and a type 2 CG PUSCH for the CP-OFDM waveform.

Aspect 13 is the apparatus of aspect 11, where the at least one indication indicates: the at least one total number of supported UL resource muting patterns associated with the type 1 CG PUSCH, a dynamic grant (DG) PUSCH, and a type 2 CG PUSCH for the DFT-s-OFDM waveform.

Aspect 14 is the apparatus of aspect 11, where the at least one indication indicates the at least one total number of supported UL resource muting patterns associated with the type 1 CG PUSCH for the CP-OFDM waveform, and where a first total number of supported UL resource muting patterns associated with a dynamic grant (DG) PUSCH and a type 2 CG PUSCH for the CP-OFDM waveform is one.

Aspect 15 is the apparatus of aspect 11, where the at least one indication indicates the at least one total number of supported UL resource muting patterns associated with the type 1 CG PUSCH for the DFT-s-OFDM waveform, and where a first total number of supported UL resource muting patterns associated with a dynamic grant (DG) PUSCH and a type 2 CG PUSCH for the DFT-s-OFDM waveform is one.

Aspect 16 is the apparatus of aspect 11, where the at least one indication indicates: the at least one total number of supported UL resource muting patterns associated with the type 1 CG PUSCH, a dynamic grant (DG) PUSCH, and a type 2 CG PUSCH for the CP-OFDM waveform and the DFT-s-OFDM waveform.

Aspect 17 is the apparatus of aspect 11, where the at least one indication indicates the at least one total number of supported UL resource muting patterns associated with the type 1 CG PUSCH for the DFT-s-OFDM waveform and the CP-OFDM waveform, and where a first total number of supported UL resource muting patterns associated with a dynamic grant (DG) PUSCH and a type 2 CG PUSCH for the DFT-s-OFDM waveform and the CP-OFDM waveform is one.

Aspect 18 is the apparatus of any of aspects 11-17, where the at least one indication indicates the at least one total UL resource muting number of symbols per slot for the type 1 CG PUSCH, a dynamic grant (DG) PUSCH, and a type 2 CG PUSCH.

Aspect 19 is the apparatus of aspect 18, where the at least one total UL resource muting number of symbols per slot for the type 1 CG PUSCH, the DG PUSCH, and the type 2 CG PUSCH corresponds to one maximum total UL resource muting number of symbols per slot for a combination of the type 1 CG PUSCH, the DG PUSCH, and the type 2 CG PUSCH.

Aspect 20 is the apparatus of aspect 19, where the at least one processor is further configured to: refrain from configuring a UL muting configuration that indicates a set of UL muting symbols per slot where a quantity of the set of UL symbols per slot is larger than the maximum total UL resource muting number of symbols.

Aspect 21 is a method of wireless communication for implementing any of aspects 1 to 10.

Aspect 22 is a computer-readable medium (e.g., a non-transitory computer-readable medium) storing computer executable code, the code when executed by at least one processor causes the at least one processor to implement any of aspects 1 to 10.

Aspect 23 is an apparatus comprising means for implementing any of aspects 1 to 10.

Aspect 24 is a method of wireless communication for implementing any of aspects 11 to 20.

Aspect 25 is a computer-readable medium (e.g., a non-transitory computer-readable medium) storing computer executable code, the code when executed by at least one processor causes the at least one processor to implement any of aspects 11 to 20.

Aspect 26 is an apparatus comprising means for implementing any of aspects 11 to 20.

What is claimed is:

1. An apparatus for wireless communication at a user equipment (UE), comprising:
at least one memory; and
at least one processor coupled to the at least one memory, and based at least in part on information stored in the at least one memory, the at least one processor is configured to:
transmit, to a network node, at least one UE capability signaling comprising at least one indication of:
at least one total number of supported uplink (UL) resource muting patterns associated with a type 1 configured grant (CG) physical uplink shared channel (PUSCH) for at least one of a cyclic prefix (CP)-orthogonal frequency division multiplexing (OFDM) (CP-OFDM) waveform and a discrete Fourier transform-spread OFDM (DFT-s-OFDM) waveform; or
at least one total UL resource muting number of symbols per slot; and
communicate with the network node based on the at least one UE capability signaling.

2. The apparatus of claim 1, wherein the at least one indication indicates:
the at least one total number of supported UL resource muting patterns associated with the type 1 CG PUSCH, a dynamic grant (DG) PUSCH, and a type 2 CG PUSCH for the CP-OFDM waveform.

3. The apparatus of claim 1, wherein the at least one indication indicates:
the at least one total number of supported UL resource muting patterns associated with the type 1 CG PUSCH, a dynamic grant (DG) PUSCH, and a type 2 CG PUSCH for the DFT-s-OFDM waveform.

4. The apparatus of claim 1, wherein the at least one indication indicates the at least one total number of supported UL resource muting patterns associated with the type 1 CG PUSCH for the CP-OFDM waveform, and wherein a first total number of supported UL resource muting patterns associated with a dynamic grant (DG) PUSCH and a type 2 CG PUSCH for the CP-OFDM waveform is one.

5. The apparatus of claim 1, wherein the at least one indication indicates the at least one total number of supported UL resource muting patterns associated with the type 1 CG PUSCH for the DFT-s-OFDM waveform, and wherein a first total number of supported UL resource muting patterns associated with a dynamic grant (DG) PUSCH and a type 2 CG PUSCH for the DFT-s-OFDM waveform is one.

6. The apparatus of claim 1, wherein the at least one indication indicates:
the at least one total number of supported UL resource muting patterns associated with the type 1 CG PUSCH, a dynamic grant (DG) PUSCH, and a type 2 CG PUSCH for the CP-OFDM waveform and the DFT-s-OFDM waveform.

7. The apparatus of claim 1, wherein the at least one indication indicates the at least one total number of supported UL resource muting patterns associated with the type 1 CG PUSCH for the DFT-s-OFDM waveform and the CP-OFDM waveform, and wherein a first total number of supported UL resource muting patterns associated with a dynamic grant (DG) PUSCH and a type 2 CG PUSCH for the DFT-s-OFDM waveform and the CP-OFDM waveform is one.

8. The apparatus of claim 1, wherein the at least one indication indicates the at least one total UL resource muting number of symbols per slot for the type 1 CG PUSCH, a dynamic grant (DG) PUSCH, and a type 2 CG PUSCH.

9. The apparatus of claim 8, wherein the at least one total UL resource muting number of symbols per slot for the type 1 CG PUSCH, the DG PUSCH, and the type 2 CG PUSCH corresponds to one maximum total UL resource muting number of symbols per slot for a combination of the type 1 CG PUSCH, the DG PUSCH, and the type 2 CG PUSCH.

10. The apparatus of claim 9, wherein the at least one processor is further configured to:
receive a UL muting configuration that indicates a set of UL muting symbols per slot, wherein a quantity of the set of UL symbols per slot larger than the maximum total UL resource muting number of symbols; and
refrain from applying UL muting for a portion of the set of UL muting symbols based on the maximum total UL resource muting number of symbols per slot and a time order of the set of UL muting symbols per slot.

11. An apparatus for wireless communication at a network node, comprising:
at least one memory; and
at least one processor coupled to the at least one memory, and based at least in part on information stored in the at least one memory, the at least one processor is configured to:
receive, from a user equipment (UE), at least one UE capability signaling comprising at least one indication of:
at least one total number of supported uplink (UL) resource muting patterns associated with a type 1 configured grant (CG) physical uplink shared channel (PUSCH) for at least one of a cyclic prefix (CP)-orthogonal frequency division multiplexing (OFDM) (CP-OFDM) waveform and a discrete Fourier transform-spread OFDM (DFT-s-OFDM) waveform; or
at least one total UL resource muting number of symbols per slot; and
communicate with the UE based on the at least one UE capability signaling.

12. The apparatus of claim 11, wherein the at least one indication indicates:
the at least one total number of supported UL resource muting patterns associated with the type 1 CG PUSCH, a dynamic grant (DG) PUSCH, and a type 2 CG PUSCH for the CP-OFDM waveform.

13. The apparatus of claim 11, wherein the at least one indication indicates:
the at least one total number of supported UL resource muting patterns associated with the type 1 CG PUSCH, a dynamic grant (DG) PUSCH, and a type 2 CG PUSCH for the DFT-s-OFDM waveform.

14. The apparatus of claim 11, wherein the at least one indication indicates the at least one total number of supported UL resource muting patterns associated with the type 1 CG PUSCH for the CP-OFDM waveform, and wherein a first total number of supported UL resource muting patterns associated with a dynamic grant (DG) PUSCH and a type 2 CG PUSCH for the CP-OFDM waveform is one.

15. The apparatus of claim 11, wherein the at least one indication indicates the at least one total number of supported UL resource muting patterns associated with the type 1 CG PUSCH for the DFT-s-OFDM waveform, and wherein a first total number of supported UL resource muting patterns associated with a dynamic grant (DG) PUSCH and a type 2 CG PUSCH for the DFT-s-OFDM waveform is one.

16. The apparatus of claim 11, wherein the at least one indication indicates:
the at least one total number of supported UL resource muting patterns associated with the type 1 CG PUSCH, a dynamic grant (DG) PUSCH, and a type 2 CG PUSCH for the CP-OFDM waveform and the DFT-s-OFDM waveform.

17. The apparatus of claim 11, wherein the at least one indication indicates the at least one total number of supported UL resource muting patterns associated with the type 1 CG PUSCH for the DFT-s-OFDM waveform and the CP-OFDM waveform, and wherein a first total number of supported UL resource muting patterns associated with a dynamic grant (DG) PUSCH and a type 2 CG PUSCH for the DFT-s-OFDM waveform and the CP-OFDM waveform is one.

18. The apparatus of claim 11, wherein the at least one indication indicates the at least one total UL resource muting number of symbols per slot for the type 1 CG PUSCH, a dynamic grant (DG) PUSCH, and a type 2 CG PUSCH.

19. The apparatus of claim 18, wherein the at least one total UL resource muting number of symbols per slot for the type 1 CG PUSCH, the DG PUSCH, and the type 2 CG PUSCH corresponds to one maximum total UL resource muting number of symbols per slot for a combination of the type 1 CG PUSCH, the DG PUSCH, and the type 2 CG PUSCH.

20. The apparatus of claim 19, wherein the at least one processor is further configured to:
refrain from configuring a UL muting configuration that indicates a set of UL muting symbols per slot where a quantity of the set of UL symbols per slot is larger than the maximum total UL resource muting number of symbols.
